(19) United States
(12) Patent Application Publication
(10) Pub. No.: US 2017/0359396 A1
(43) Pub. Date: Dec. 14, 2017

(54) System and Method for a Broadcast Terminal and Networked Devices

(71) Applicant: Jason B. Gapasin, Los Angeles, CA (US)

(72) Inventor: Jason B. Gapasin, Los Angeles, CA (US)

(21) Appl. No.: 15/179,052

(22) Filed: Jun. 10, 2016

(51) Int. Cl. H04L 29/06; H04M 1/725; H04L 12/18

(52) U.S. Cl. CPC H04L 65/4076; H04L 12/1822; H04L 65/4038; H04L 65/601; H04M 1/7255

(57) ABSTRACT

There is provided a system including an input device configured to transmit data and a broadcast terminal configured to receive the data from the input device and simultaneously transmit the data over a local network to a plurality of computing devices in connection with the broadcast terminal. The broadcast terminal is further configured to dynamically control the transmission of the data to and the connection to each of the plurality of computing devices. The system further includes at least two computing devices configured to receive the data from the broadcast terminal over the local network and to dynamically manipulate the data to create custom data where the custom data is unique to each of the computing devices.

### FIELD OF THE INVENTION

The present invention relates generally to a broadcast terminals and networked devices. More particularly, the present invention relates to a system and method for communications between a broadcast terminal and localized networked devices.

### BACKGROUND ART

In classroom, meeting, interview, and other similar environments, people have long used personal microphones and video cameras to record audio and video data. For example, each person attending a class in a classroom, or each person in a meeting, may make use of their own personal devices, whether the device be a phone, computer, tablet, voice recorder, camera, or the like, to make a record. After making such a record, the person is able to go back over the record, make edits, make changes, transcribe the recording, create partitions in the recording using software, as well as make a variety of other changes.

However, quality and consistency issues arise when each person is relying on the components (microphone, camera, etc.) of their own personal device to create a record. For example, the active speaker in the classroom or in the meeting may be separated from the personal device by a substantial distance that may interfere with the sound quality or video quality of the record. The active speaker may not be clearly heard on the recording in such a situation. In other scenarios, there may be multiple people near the personal device that are not the active speaker, which may cause the personal device to make record of the voices of the people around the personal device rather the active speaker. As such, the final recording, whether audio, video, or a combination of the two, may not be entirely clear.

In addition, there is a lack of ability in the market for personal devices to create custom records of classes, meetings, interviews, and the like, especially during the meeting, interview, or class. Most software only allows for customization after the recording has been made.

As such, there is a need in the art for a system that allows that each attendee at a meeting, interview, classroom, or other environments where records are desired, to receive the same consistent broadcast of the active speaker and create a custom record of the broadcast.

### SUMMARY OF THE INVENTION

In one implementation of the present disclosure, there is presented a system comprising an input device configured to transmit data, a broadcast terminal configured to receive the data from the input device and simultaneously transmit the data over a local network to a plurality of computing devices in connection with the broadcast terminal, the broadcast terminal further configured to dynamically control the transmission of the data to and the connection to each of the plurality of computing devices, and at least two computing devices configured to receive the data from the broadcast terminal over the local network and to dynamically manipulate the data to create custom data, the custom data unique to each of the computing devices.

In another implementation of the present disclosure, there is presented a system comprising an input device configured to transmit data, a broadcast terminal configured to receive the data from the input device and simultaneously transmit the data over a local network to a plurality of computing devices in connection with the broadcast terminal; and at least two computing devices configured to receive the data from the broadcast terminal over the local network and to dynamically manipulate the data to create custom data, the custom data unique to each of the computing devices, wherein the manipulation of the data includes: dynamically creating partitions in the data during receiving of the data from the broadcast terminal such that the custom data includes multiple segments of the data, manually creating partitions in the data after connection with the broadcast terminal has been terminated, and associating notes and metadata tags with each of the multiple segments of the data included in the custom data.

In yet another implementation, there is presented a method comprising generating data utilizing an input device, receiving the data at a broadcast terminal, transmitting the data simultaneously, by the broadcast terminal, over a local network to a plurality of computing devices in connection with the broadcast terminal, the broadcast terminal configured to dynamically control the transmission of the data to and the connection to each of the plurality of computing devices, and receiving, by at least two computing devices in connection with the broadcast terminal, the data from the broadcast terminal over the local network, and dynamically manipulating, by each of the at least two computing devices, the data to create custom data unique to each of the computing devices.

### BRIEF DESCRIPTION OF THE DRAWINGS

FIG. 1 illustrates a system for a broadcast terminal and networked devices, according to one implementation of the present disclosure.

FIG. 2 is an additional illustration of the system for a broadcast terminal and networked devices of FIG. 1, according to one implementation of the present disclosure.

FIG. 3A illustrates a computing device and associated software application for use in the system of FIG. 1, according to one implementation of the present disclosure.

FIG. 3B is another illustration of a computing device and associated software application for use in the system of FIG. 1, according to one implementation of the present disclosure.

FIG. 3C is another illustration of a computing device and associated software application for use in the system of FIG. 1, according to one implementation of the present disclosure.

FIG. 3D is another illustration of a computing device and associated software application for use in the system of FIG. 1, according to one implementation of the present disclosure.

FIG. 4 shows a flowchart illustrating a method for use by a broadcast terminal and networked devices, according to one implementation of the present disclosure.

### DETAILED DESCRIPTION OF THE INVENTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

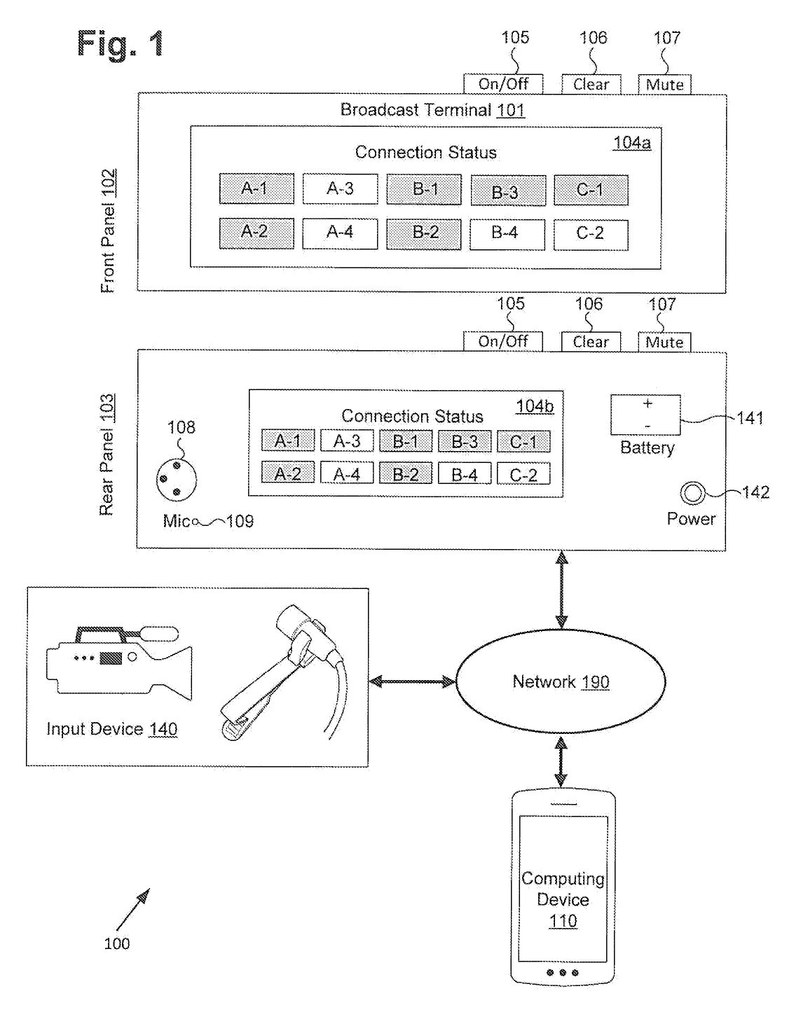

Now referring to FIG. 1, FIG. 1 illustrates a system for a broadcast terminal and networked devices, according to one implementation of the present disclosure. FIG. 1 includes system 100 that includes broadcast terminal 101, input device 140, network 190, and computing device 110. Broadcast terminal 101 includes power button 105, clear button 106, mute button 107, front panel 102, rear panel 103, connection status panel 104a and connection status panel 104b (hereinafter collectively referred to as connection panels 104), mic input 108, mic indicator 109, battery 141, and power input 142.

Broadcast terminal 101 is configured to receive input data from input device 140 over network 190 and/or over a wired connection. Broadcast terminal 101 is further configured to control transmission of the input data to computing device 110 across network 190. As such, preferably, input device 140 and computing device 110 communicate independent of each other with broadcast terminal 101. It should be noted that although rear panel 103 and front panel 102 of broadcast terminal 101 are shown to have certain features, any of the features on front panel 102 or rear panel 103 may be optionally or additionally included on the alternate panel or at another location on broadcast terminal 101. For example, mic input 108 may be included on front panel 102 instead of rear panel 103.

Front panel 102 is configured to be provide a notification to users of connected devices which channels are occupied and to users of non-connected devices which channels are currently open for connection to broadcast terminal 101. The channels are each indicated by unique identifiers, such a “A-1”, “A-2”, “B-2”, and so on.

Rear panel 103 is configured to provide the user of broadcast terminal 101 which channels are occupied and open for connection. Rear panel 103 is also configured to provide the user of broadcast terminal 101 an indication of whether input device 140 is connected, such as by way of mic indicator 109. Rear panel 103 may also allow for connection of battery power through use of battery 141, wired power through use of power input 142, and connection of input device 140 if input device 140 requires a wired connection, such as by way of mic input 108, for example.

Connection status panel 104a and 104b are configured to provide prospective devices with the open channels available for connection and to provide the user of broadcast terminal 101 the channels which are occupied and also open for communication. Although ten channels are shown on connection status screens 104, there may be any number of available channels, depending on the configuration of broadcast terminal 101 and the type of network that network 190 is. In some implementations, broadcast terminal 101 may be configured to only allow seven connections, such as in a standard piconet, where broadcast terminal 101 serves as the master device and each of the seven connected devices are the slave devices. In such an implementation, if more than seven devices are desired, broadcast terminal 101 may include multiple piconets, or additional broadcast terminals 101 may be connected in a pairing fashion.

Connection status panel 104 may be a digital display, and may be further configured for touch input. In such an implementation, each of the unique identifiers, e.g. “A-1”, “B-2”, for example, may be individually selectable. In addition, groups of unique identifiers, such as groups starting with “A”, “B”, or “C”, for example, may be selectable individually as a group. This will be described in more detail below with respect to clear button 106 and mute button 107.

When certain channels are connected this may be displayed differently than non-connected channels. For example, in the illustration of FIG. 1, channels “A-1”, “A-2”, “B-1”, “B-2”, “B-3”, and “C-1” are highlighted in gray, which may indicate these channels are occupied by a connected device, such as computing device 110, while the remaining channels are not highlighted, indicating they are available for connection.

Mic indicator 109 is configured to notify the user of broadcast terminal 101 or the user of input device 140 when input device 140 is connected. As such, mic indicator 109 may also include a video indicator (not illustrated) or presentation device indicator to notify the users that a video camera or presentation device is connected to broadcast terminal 140.

Power button 105 is configured to turn on and off broadcast terminal 101. Power button 105 may be located on the top, bottom, front panel 102, rear panel 103, and/or side panels of broadcast terminal 101. Power button 105 may be operated digitally by touch, or may be a mechanical button such as a push button.

Clear button 106 is configured to allow for clearing of connected devices, such as computing device 110. In some implementations, clear button 106 may disconnect all connected devices in communication with broadcast terminal 101. In such an implementation, clear button 106 may be a single button that may be operated similar to power button 105 described above. Once communication with a connected device has been cleared using clear button 106, the devices would then have to reconnect to broadcast terminal 101 to again receive the input data.

In other implementations, broadcast terminal 101 may be configured to selectively clear connected devices individually or in groups. For example, each of the device identifiers on the connection status screen 104 may be its own individual button that when pressed, or selected, clears the connection with that device. In such an example, if computing device 110 was connected as device A-1 on the connection status screen 104, the user of broadcast terminal 101 may be able to press “A-1” on the connection status screen 104 to clear the connection between broadcast terminal 101 and computing device 110.

In another example, broadcast terminal 101 may be configured to clear connections with groups of connected devices, such as a first group of devices starting with “A”, a second group of devices starting with “B”, and a third group of devices starting with “C”. In such an example, groups “A”, “B”, and “C” may each have a clear button 106 associated with them, such that the user of broadcast terminal 101 can selectively clear the connection between broadcast terminal 101 and the group of connected devices, one of which may include computing device 110.

Mute button 107 is configured to selectively mute or stop the transmission of the input data from broadcast terminal 101 to any of the connected devices, including computing device 110, while maintaining the connection with said connected devices. In some implementations, mute button 107 may be a single button that mutes the transmission of the input data to all of the connected devices. In such an implementation, mute button 107 may be a single button that may be operated similar to power button 105 described above.

In other implementations, similar to that described above with reference to clear button 106, mute button 107 may be associated with each individual device of the connected devices or may be associated with groups of connected devices, such as group “A”, “B”, or “C”, for example. As such, mute button 107 may temporarily stop transmission of the input data to certain connected devices while continuing transmission of the input data to the non-muted connected devices.

Mute button 107 may also include a video mute button and an audio mute button such that only the video data or only the audio data, respectively, are muted to certain devices, or both audio data and video data may be muted. As such, in some implementations, the user of broadcast terminal 101 may not want video data to be transmitted to certain devices, such as computing device 110, and may thus select the video mute button to stop video data transmission to selected devices, or to all connected devices. For example, if during a broadcast, an individual being recorded on video falls, or has a clothing malfunction, the video data can be muted temporarily while the audio continues. In such an example, the connected devices don't lose the audio data which may be important to their recording of the event and the user of the broadcast terminal also prevents the video data including the unwanted footage from being transmitted to the connected devices.

In another example, there may be blind and/or deaf audience members, and the video mute button or audio mute button may be used to selectively mute the transmission of data in the form of audio or video to the connected devices that have users who are not capable of viewing or hearing the information. For example, in implementations where computing device 110 is a braille notetaker or similar device that has functionality to assist blind audience members, the video mute button may be selected and the user of the braille notetaker will only receive the audio data. In such an example, network 190 may be freed up to allow more bandwidth and faster transmission of the input data while simultaneously removing the input data not relevant to the selected users.

Input device 140 is configured to communicate with broadcast terminal 101 over network 190 and/or over a wired connection, such as through mic input 108 or a video input (not illustrated). Input device 140 communicates the input data to broadcast terminal 140 in response to receiving an input, e.g. voice or video input. Input device 140 may include a microphone (illustrated), a video camera (illustrated), a voice recorder, or any other device capable of generating voice data, video data, and/or presentation data, i.e. input data. Although both a microphone and a video camera are illustrated in FIG. 1, system 100 may utilize one or more input devices 140, including presentation devices, for example, such as a computer configured to transmit input data in the form of a slideshow. In addition, input device 140 may be configured to communicate with computing device 110 over network 190. However, in system 100, broadcast terminal 101 preferably controls the communication of the input data from input device 140 transmitted to computing device 110 so that broadcast terminal 101 can selectively mute or clear the connection to computing device 110 during transmission of the input data, as described in more detail above with respect to broadcast terminal 101.

In some implementations, specifically where the user of input device 140 is a blind, input device 140 may include a braille notetaker type device that allows a blind user to communicate data over network 190 to an audience through broadcast terminal 101. The braille notetaker may be any braille notetaker available on the market, including for example, the BrailleNote Apex BT by Humanware, which is one suitable example of a braille notetaker that may be utilized as input device 140. Those of ordinary skill in the art will understand the functionality and usability of a braille notetaker in system 100.

Computing device 110 is configured to communicate with broadcast terminal 101 over network 190. More specifically, computing device 110 is configured to receive the input data from broadcast terminal 101 and customize the input data, dynamically while receiving the input data, and/or after the input data is received. Computing device 110 may include a mobile device, a computer, a tablet, a voice recorder, or any device capable of receiving the input data from broadcast terminal 101 over network 190, and customizing the input data dynamically during receipt of the input data and after the input data has been received. Although computing device 110 is shown as a single device, system 100 preferably includes multiple computing devices 110 in communication with broadcast terminal 101 over network 190.

In some implementations, at least one of computing devices 110 may include a braille notetaker type device, such as that described above with respect to input device 140. In such an implementation, the braille notetaker may receive the input data from broadcast terminal 101 over network 190 in audio or textual form. If the input data is received in textual form, the braille notetaker has the capability to convert the text to braille or to convert the text to audio in order to allow the blind user to understand the input data. Once the blind user has the input data in braille or audio form, the blind user can subsequently modify the input data to create custom data.

Network 190 is configured to facilitate communication between input device 140 and broadcast terminal 101 as well as computing device 110 and broadcast terminal 101. Network 190 may include multiple network types, and input device 140 may communicate with broadcast terminal 101 over a different type of network than computing device 110 uses to communicate with broadcast terminal 101. Network 190 is preferably a local area network (LAN) or a personal area network (PAN). System 100 preferably utilizes a network type for network 190 that allows the users of computing device 110 and the users of input device 140 to be in visual and/or audible range of each other. However, in some implementations, users of input device 140 and users of computing device 110 may communicate over a network type that extends beyond audio and/or visual range. Network 190 may be a Bluetooth network, a wireless fidelity (Wi-Fi) network, a wired network such as Ethernet or broadband, a ZigBee network, or another suitable network type.

Below are provided three example of practical uses of system 100. Example A, B, and C are provided to explain a few of the practical applications of system 100. However, these examples are in no way limiting, and are only provided for exemplary purposes.

Example A includes the use of system 100 in a classroom setting. In such an example, a teacher may utilize input device 140, which may be a lavalier microphone, to instruct the class. Input device 140 will thus generate the input data to be transmitted to broadcast terminal 101.

Some or all of the students may desire to make a record of the classroom discussion. The students may each utilize their own device, such as computing device 110, to connect to broadcast terminal 101. The students may connect their devices to broadcast terminal 101 over network 190. Students may make note of the open connection channels by utilizing the connection status screen 104a on the front panel 102 of broadcast terminal 101, and may connect to the open channels based on the unique identifier, e.g. “A-1”. The teacher, in return, is able to view which channels are connected to and which are still open utilizing connection status screen 104b. The teacher may have a pin that is required for connection to broadcast terminal 101. When each student attempts to connect, they may enter the pin to establish a connection. In some implementations, different groups of students may have a different pin, such that partitioned groups are created among the students, e.g. group A or group B, as described above. As such, the teacher would be able to selectively clear and/or mute the groups of students all at once, or clear individual students connected devices, utilizing clear button 106 and mute button 107.

The connected devices of the students may then each receive the input data from broadcast terminal 101. Each of the connected devices may receive the same input data, or as described above, may receive differing input data depending on if their device is muted or cleared during any part of the discussion. The benefit of each of the connected devices receiving the input data directly from broadcast terminal 101 is that each of the connected devices is allowed access to the original input data, which is generally much more clear than individual recordings made by components of the connected devices. Either way, each of the connected devices is configured to edit or modify the input data during reception of the input data or after the input data is received. For example, each student may make their own partitions in the recording during the recording, or make their own unique notes for segments of the recording during the recording. Students may add flags indicating a change in topic, or when the professor stops talking and another student begins talking, etc. As such, at the end of the discussion, when the teacher clears all of the connected devices using clear button 106, each of the previously connected devices can have their own unique recording of the classroom discussion together with notes and flags for further review or editing which all constitute custom data. As such, the input data from input device 140 is dynamically modified by the connected devices, such as computing device 110, to create custom data potentially unique to each of the connected devices.

The above example can also be utilized if one of the students is a deaf or blind student. For example, if one of the students is deaf, that student may only receive video and/or textual data of the input data and the audio data may be muted. However, even if the deaf student does receive the audio data the software on computing device 110 may utilize a transcriber to convert the audio data to textual data, as will be described in greater detail below. For another example, if the student is blind, the student may only receive audio and textual data on a braille notetaker type device. In such an example, the braille notetaker has the capability to convert textual data to braille or audio to be output to the blind student allowing them to understand the input data.

Example B includes the use of system 100 in an interview environment, such as an athlete interview, or the like. In such an example, the interviewee, or the athlete in this case, may have a microphone and/or video camera recording them during the interview. The microphone and/or video camera will thus generate input data to be transmitted to broadcast terminal 101.

Any of a number of news stations or individuals may wish to make a record of the interview, and may thus connect their devices to broadcast terminal 101. The user of broadcast terminal 101, which may not be the interviewee, may control which devices are connected, and control which devices connect to which identifiers. For example, certain news stations or individuals may be assigned unique identifiers and corresponding pins for connection to specified channels on broadcast terminal 101. As such, the user of broadcast terminal 101 is able to selectively mute or clear the connected devices belonging to certain news stations or individuals. For example, some of the news stations may be known for sending videos viral, so the user of broadcast terminal 101 may wish to mute the video data and/or audio data transmission to that news station if a sensitive question is asked, or if something happens during the interview that the user may not want in the hands of a particular news station or individual, but selectively muting the channel of the news stations connected device.

Each of the news stations or individuals that have connected devices can thus receive the input data from broadcast terminal 101 and edit the input data to create custom data, similar to that described in Example A above. For example, each of the connected devices may create partitions during reception of the input data to create shortened clips, where each clip may correspond to one questions and answer, or to one interviewee, etc. As such, during recording, as partitions are created and the input data is dynamically segmented by each connected device, the news stations or individuals associated with each connected device can transmit their custom data to their news station or to their friends, even while the connected device continues to receive the remainder of the input data from broadcast terminal 101. In addition, by dynamically editing and customizing the input data on individual connected devices, the news stations or individuals are able to create their own unique recordings in real time for faster transmission to the public, without having to playback the recording to make the necessary edits. However, each of the connected devices may wish to go back and playback the recording and make additional edits or partitions, as well as add notes and other information to the custom data.

Example C includes the use of system 100 in a meeting environment. In such an example, input device 140 may include a microphone and/or video camera and/or computing device, including presentation data, that is presented to each participant in the meeting. The microphone and/or video camera and/or computing device may generate input data to be communicated to broadcast terminal 101 over network 190 or through a wired connection.

The attendees of the meeting may each wish to create their own record of the input data from the meeting, including audio data, video data, and/or presentation data. The user of broadcast terminal 101 may thus be able to control which of the connected devices belonging to the attendees of the meeting should receive each type of the input data. For example, if the meeting involves a plaintiffs side and a defendants side in a court case, there may be certain input data that the user of broadcast terminal 101, does not want transmitted to the opposing side. More specifically, the user may not desire that the opposing side have a record of the presentation data, which may include a slideshow of information pertaining to important information in the case. For another example, the user of the broadcast terminal 101, during private discussion, may mute the opposing sides audio data to prevent the opposing side from having a record of the private conversation.

Each of the attendees of the meeting may wish to make a record of the audio data, video data, and/or presentation data, i.e. input data. During reception of the input data, the attendees may partition the audio data, video data, and/or presentation data into their own custom form as custom data. For example, the attendees may utilize their connected devices to partition the audio data associated with each slide of a slideshow included in the presentation data, and include a note related to the presentation data to remind the attendee of the relevance of the slide. Ultimately, the user of broadcast terminal 101 may clear the connection between all of the connected devices, including computing device 110, at the conclusion of the meeting using clear connection button 106.

As such, in each of examples A, B, and C, the user of broadcast terminal 101 is able to control the transmission of the input data to the connected devices so that only the desired connected devices receive the input data intended for them. In addition, each of the connected devices is able to dynamically edit and customize the input data to create custom data during and after the reception of the input data from broadcast terminal 101. In this way, each of the connected devices receive the input data of the same quality, a quality of which is in most cases higher quality than if the components of the connected devices were utilized in generating the input data, and at the same time the broadcast terminal 101 is able to control how much input data each connected device is privy to.

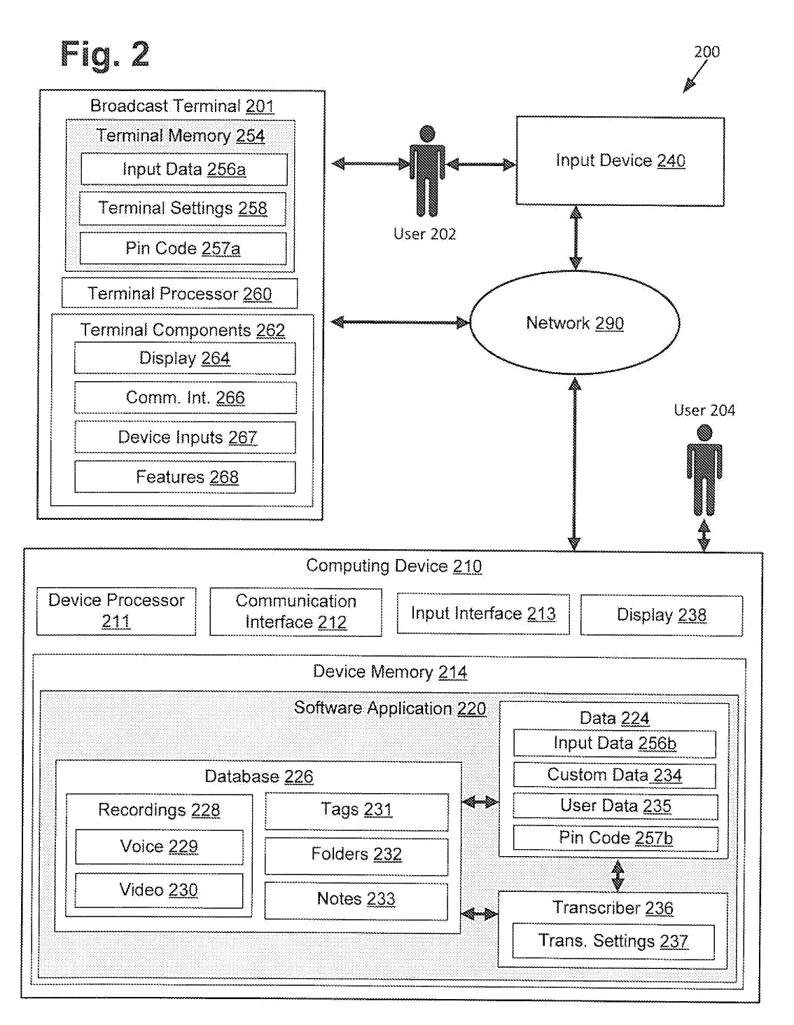

Now referring to FIG. 2, FIG. 2 is an additional illustration of the system for a broadcast terminal and networked devices of FIG. 1, according to one implementation of the present disclosure. FIG. 2 includes input device 240, broadcast terminal 201, network 290, computing device 210, user 202 and user 204. Broadcast terminal 201 includes terminal memory 254 which includes input data 256a, terminal settings 258, and pin code 257a, terminal processor 260, and terminal components 262 which includes display 264, communication interface 266, device inputs 267, and features 268. Computing device 210 includes device processor 211, communication interface 212, input interface 213, display 238, and device memory 214 which includes software application 220. Software application 220 includes database 226 which includes recordings 228 which includes voice 229, and video 230, and data 224 which includes input data 256b, historical data 234, user data 235, and pin code 257b, and transcriber 236 which includes transcriber settings 237.

It should be noted that input device 240, network 290, broadcast terminal 201, and computing device 210 correspond respectively to input device 140, network 190, broadcast terminal 101, and computing device 110 of FIG. 1.

Input device 240 is configured to communicate over network 290 or a wired connection with broadcast terminal 201, and specifically to communicate input data 256a to broadcast terminal 201. Input device 240 may be a microphone, a video camera, a computing device, a braille notetaker, a voice recorder, or the like. Input data 256a generated by input device 240 may be transmitted as voice data, audio data, and presentation data, for example. As such, broadcast terminal 201 may receive input data 256a in an audio format, a video format, and a presentation format (e.g. textual or slideshow format) to enable broadcast terminal 201 to selectively transmit only the audio data, the video data, and/or the presentation data as input data 256a to computing device 210.

User 202 may control input device 240 in addition to broadcast terminal 201, or different users may control input device 240 and broadcast terminal 201. Input device 240 may communicate with broadcast terminal 201 over a Bluetooth connection, in which case network 290 would include a Bluetooth network.

Network 290 may be any network capable of handling the communication between both input device 240 and broadcast terminal 201, and between computing device 210 and broadcast terminal 201. Network 290 may include different network types. For example, input device 240 may communicate with broadcast terminal 201 using a Bluetooth network while broadcast terminal 201 communicates with computing device 210 over a Wi-Fi network.

Broadcast terminal 201 is configured to receive input data 256a from input device 240 and control the transmission of input data 256a to computing device 210. More detailed information about broadcast terminal 201 controlling the transmission of input data 256a to computing device 210 is included above with respect to broadcast terminal 101 and computing device 110 of FIG. 1.

Broadcast terminal 201 includes terminal memory 254 and terminal processor 260. Terminal processor 260 is be configured to access terminal memory 254 to store the received input data 256a or to execute commands, processes, or programs stored in terminal memory 254 or to operate terminal components 262. Terminal processor 260 may correspond to a processing device, such as a microprocessor or similar hardware processing device, or a plurality of hardware or software devices. Terminal memory 254 is a sufficient memory capable of storing commands, processes, and programs for execution by terminal processor 260.

Terminal memory 254 includes input data 256a. Input data 256a, as described above, includes the data received from input device 240. Input data 256a may be stored as separate data types, or may be stored together as a single input data 256a. For example, input data 256a may be stored as audio data from a microphone, video data from a video camera, and presentation data from a computing device, where the microphone, video camera, and computing device are all includes as input device 240. In such an example, broadcast terminal 201 is configured to separately or in combination deliver each of the data types as input data 256a over network 290. In another example, each of the audio, video, and presentation data may be stored together such that broadcast terminal 201 transmits each of the different data types as input data 256a together as a single stream over network 290.

Terminal memory 254 further includes terminal settings 258. Terminal settings 258 may include settings for storage formats of input data 256a, as described above, and may include the settings for muting, clearing, and connecting to input device 240 and computing device 210. Terminal settings 258 may also include the settings for display 264, communication interface 266, device inputs 267, and features 268, which will be described in more detail below. Ultimately, terminal settings 254 are configured to establish the settings for internal components of broadcast terminal 201 and settings for communication between external devices, such as input device 240 and computing device 210.

Terminal memory 254 further includes pin code 257a. Pin code 257a is a unique code that is used in pairing input device 240 with broadcast terminal 201 and computing device 210 with broadcast terminal 201. Pin code 257a may be numerical code, a textual code, or a combination of the two. For example, pin code 257a may be an access code for establishing the connection between input device 240 and broadcast terminal 201. In addition, pin code 257a may include an access code for computing device 210 to establish connection with broadcast terminal 201. Each of the devices, including computing device 210, that establish communication with broadcast terminal 201 may require pin code 257a in order to do so. In some implementations, each device may require a unique pin code 257a such that certain channels can be associated with individual pin codes 257a. In other implementations, groups of devices may have the same pin code 257a while other groups have a different pin code 257a. In such an implementation, user 202 of broadcast terminal 201 is able to determine which devices connect to which channels as each channel or group of channels may have pin code 257a associated with it. Referring to FIG. 1, as described above, groups A, B, and C may have unique pin codes 257a. User 202 of broadcast terminal 201 may give the unique pin codes 257a for devices, such as computing device 210, based on what input data 256a user 202 desires each device to be privy to.

For example, referring back to Example C above with respect to FIG. 1, user 202 may give a first pin code to the opposing counsel, and a second pin code to plaintiffs counsel, such that opposing counsel connects as Group A and plaintiffs counsel connects as Group B. As such, opposing counsel and plaintiffs counsel are automatically connected under their specified groups so that user 202 can selectively mute any transmission of input data 256a of any type at any time to either opposing or plaintiffs counsel or both. The same process can be used for clearing the connection between the devices and broadcast terminal 201.

Broadcast terminal 201 further includes terminal components 262. Terminal components 262 include display 264. It should be noted that display 264 includes connection status panel 104 of FIG. 1. In addition, display 264 may include additional displays, or a larger display for not only displaying the connection status of the channels of broadcast terminal 201 but also to display the connection status of input device 240, connection to network 290, power type, such as battery or wired, or any other desired displayable info. In addition, display 264 may include mute, clear, and power buttons, having functionalities such as those described above with reference to FIG. 1.

Display 264 may include a liquid crystal display (“LCD”), a light-emitting diode (“LED”), an organic-emitting diode (“OLED”), or another suitable display screen built into broadcast terminal 201 that performs physical transformation of signals to light. In some implementations, display 264 may also be touch sensitive to allow for user 202 to select channels, groups of channels, or all of the channels for muting, clearing, or establishing connections between computing device 210, and any additional devices.

Communication interface 266 includes any device that is capable of both transmitting data with a transmitter and receiving data with a receiver. Broadcast terminal 101 may communicate with input device 240 and computing device 210 over network 290 using communication interface 266. For example, communication interface 266 may utilize, for example, one or more of Wi-Fi, Worldwide Interoperability for Microwave Access (“WiMax”), Bluetooth, or any other wired or wireless technology, depending on the network type of network 290.

Terminal components 262 further includes device inputs 267. Device inputs 267 includes the inputs for input device 240, if input device 240 has a wired connection, the power input, the battery input, or any other inputs necessary for operability of broadcast terminal 201.

Terminal components 262 further includes features 268. Features 268 includes the features described above, including those described in more detail with respect to FIG. 1, including the clear button, the mute button, and the mic indicator or other indicators depending on the type of device input device 240 is.

Now referring to computing device 210, computing device 210 is configured to communicate with broadcast terminal 201 over network 290. Computing device 210 may include any number of devices. Computing device 210 may include laptop computers, desktop computers, tablets, mobile devices, braille notetakers, voice recorders, or the like.

Computing device 210 includes device memory 214 and device processor 211. Device processor 211 is be configured to access device memory 214 to store the received input data 256b or to execute commands, processes, or programs stored in device memory 214 and to operate software application 220. Device processor 211 may correspond to a processing device, such as a microprocessor or similar hardware processing device, or a plurality of hardware or software devices. Device memory 214 is a sufficient memory capable of storing commands, processes, and programs for execution by device processor 211.

Computing device 210 additionally includes communication interface 212. Communication interface 212 includes any device that is capable of receiving data with a receiver, such as input data 256b, but also may be configured to transmit data with a transmitter. Computing device 210 may communicate with broadcast terminal 101 over network 290 using communication interface 212. For example, communication interface 212 may utilize, for example, one or more of Wi-Fi, WiMax, Bluetooth, or any other wired or wireless technology, depending on the network type of network 290.

Computing device 210 further includes input interface 213. Input interface 213 may include, for example, a keyboard, a mouse, a game controller, a touch-screen input, a thermal and/or electrical sensor, or any other device capable of accepting input from user 204 of computing device 210. In implementations where computing device 210 is a braille notetaker, such as those described above with reference to FIG. 1, the input interface may actually be a combination of a keyboard (QWERTY or the like) and a braille keyboard.

Computing device 210 further includes display 238. Display 238 may include a liquid crystal display (“LCD”), a light-emitting diode (“LED”), an organic-emitting diode (“OLED”), or another suitable display screen built into computing device 210 that performs physical transformation of signals to light. In some implementations, display 238 may also be touch sensitive and may serve as one of the devices included in input interface 213.

User 204 is the user of computing device 210. However, because computing device 210 may include any number of devices, user 204 may include each user of each device.

Device memory 214 includes software application 220. Software application 220 is configured to allow user 204 to control the reception of and the manipulation of input data 256b to create custom data 234. In addition, software application 220 allows user 204 to create and modify database 226, as well as control the operation of transcriber 236.

Software application 220 includes data 224. Data 224 includes input data 256b. Input data 256b corresponds to input data 256a, except user 202 of broadcast terminal 201 controls which of input data 256a is transmitted to computing device 210. For example, if input data 256a includes audio and video data, input data 256b may only include the audio data if user 202 determines that computing device 210 should only receive the audio data and not the video data. In some implementations, however, computing device 210 may include all of input data 256a. In such an implementation, input data 256a and input data 256b are identical.

Data 224 further includes custom data 234. Similar to the custom data described above with respect to FIG. 1, user 204 of computing device 210 may manipulate input data 256b received from broadcast terminal 201 to create custom data 234. For example, user 204 may create partitions, add notes 233, tags 231, or create a transcription of the audio data of input data 256b using transcriber 236. Software application 220 enables user 204 to dynamically modify input data 256b during reception of input data 256b, as well as edit and modify input data 256b after reception, such as during playback. As such, user 204 may generate a unique set of data, as custom data 234, simultaneously with the transmission of input data 256a from broadcast terminal 201. In implementations where computing device 210 includes multiple devices, each of the devices are thus configured to create custom data 234 unique to each individual device dynamically and simultaneously with reception of input data 256b from broadcast terminal 201 over network 290. In addition, because input data 256a being transmitted from broadcast terminal 201 is of the same quality for each of the computing devices 210, each of the computing devices 210 is able to create custom data 234 of the same quality as any other computing device 210, independent of their location in the network, such as their proximity to user 202 of input device 240.

Data 224 further includes user data 235. User data 235 may be the user name, location, age, etc., as well as a class schedule of the user, teacher names, classmate names, colleague names, meeting schedules, speaker names, opposing counsel names, or any other similar data stored on software application for use by user 204 of computing device 210 when creating custom data 234.

Data 224 additionally includes pin code 257b. Pin code 257b corresponds to pin code 257a on broadcast terminal 201. Pin code 257b is the unique identifier code used for computing device 210 to connect to broadcast terminal 201.

Software application 220 additionally includes database 226. Database 226 is configured to store recordings 228, tags, 231, folders 232, and notes 233, among other information. Recordings 228 includes the recordings made by computing device 210 using software application 220 or transferred to computing device 210 after being recorded by another device. For example, after reception of input data 256b, and customization during the reception by user 204 to create custom data 234, the final recording may be saved in recordings 228. Recordings 228 may be saved as separate voice 229 and video 229 recordings. In addition, recordings 228 may include presentation data or other types of recordings. Recordings 228 allow user 204 to go back after initial reception of input data 256b and modification of input data 256b to create custom data 234 to further edit, modify, and customize the custom data 234 and input data 256b to create updated recordings 228.

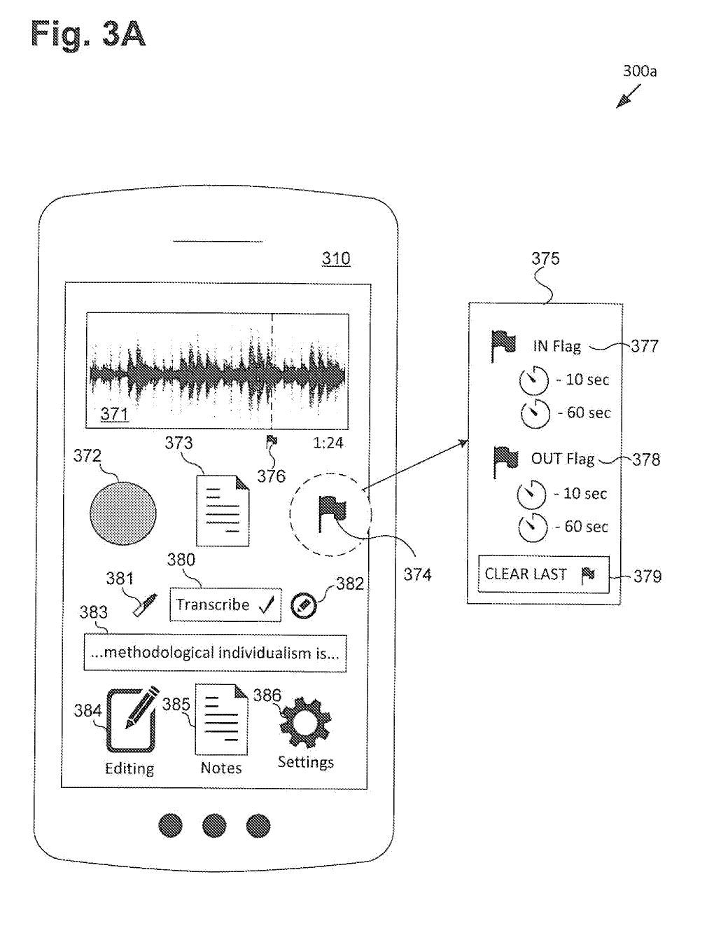

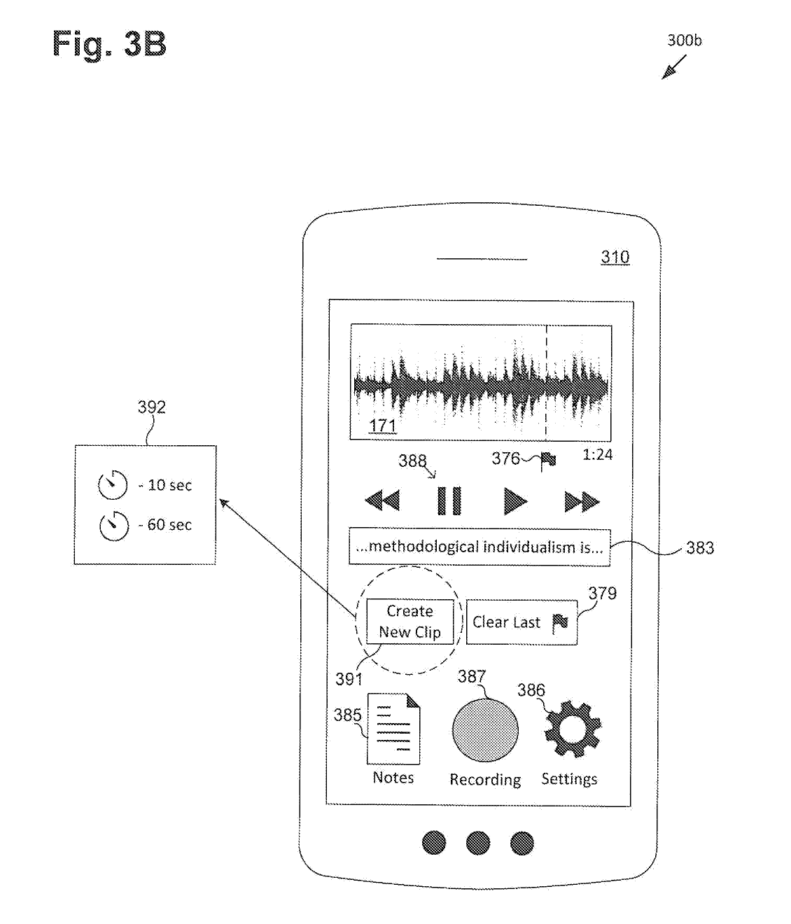

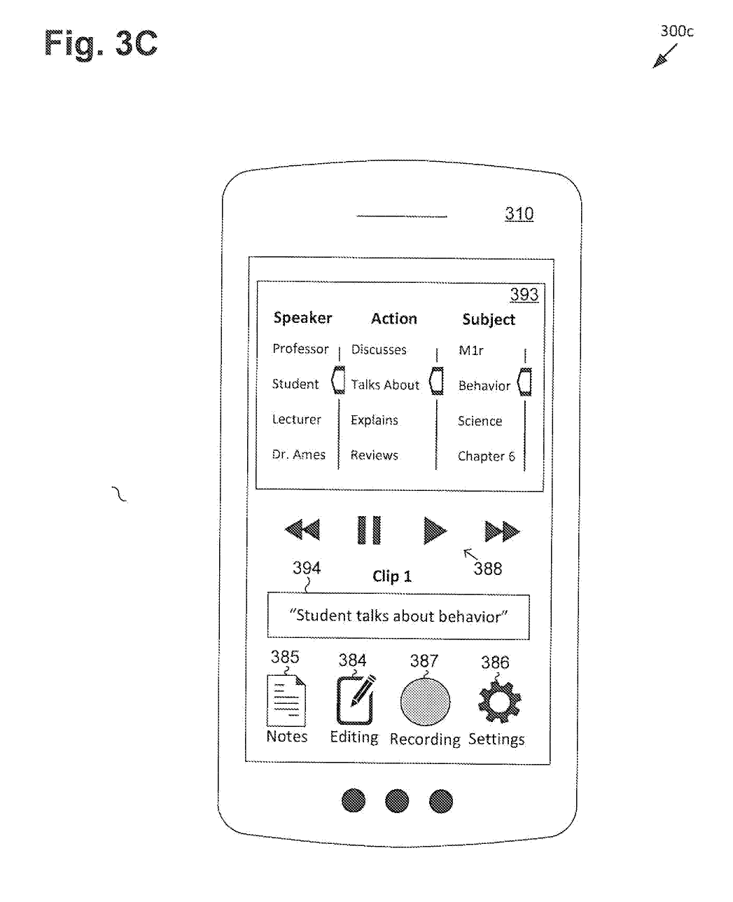

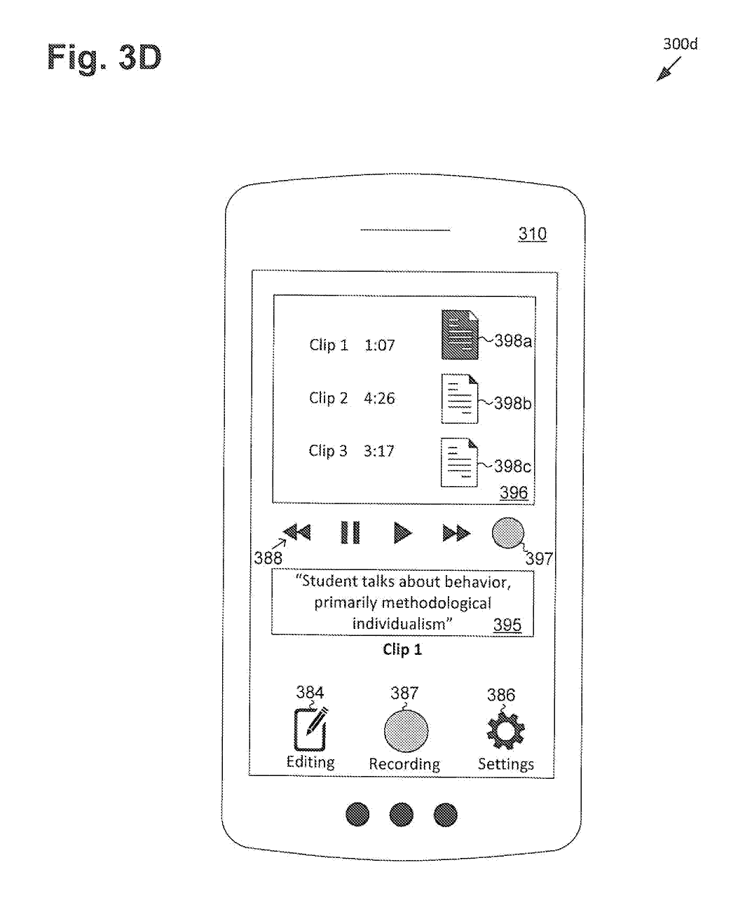

In editing input data 256b to create custom data 234, and in editing recordings 228 to create updated recordings 228, user 204 may utilize tags 231, notes 233, and folders 232. Tags 231 include flags indicating to user 204 that a partition should be created, or the like. Tags 231 may also include word tags, such as topics of discussion, or other user generated tags such as “question” when a question is asked and “answer” when the answer is being given. This allows user 204 to search through recordings 228 for certain and desired information. More information related to tags 231 is explained in FIGS. 3A-3D below.

Database 226 further includes folders 232. Folders 232 help user 204 organize recordings 228 into separate folders dependent on topic, chapter, lesson, argument, or any other criteria user 204 deems necessary for folders 232.

Database 226 additionally includes notes 233. Notes 233 include recorded, typed, or tagged notes. For example, user 204 may type notes dynamically during reception of input data 256b to create custom data 234, or may type notes during playback to create updated recordings 228. Notes 233 indicate to user 204 what recordings 228 are about for quick reference. Because notes 233 can be created dynamically during reception of input data 256b, user 204 is not required to playback each segment of recordings 228 to insert notes 233. In other examples, tags 231 may be short key words which can be utilized as notes. For example, one of tags 231 may be “chapter 6,” in which case user 204 can tag a segment of input data 256b with a “chapter 6” tag such that input data 256b becomes custom data 234 having the tag included as a note along with the recording 228.

It should be noted that each of tags 231, folders 232, and notes 233 are configured to be dynamically associated with input data 256b to create custom data 234, and ultimately recordings 228 that are unique to each computing device 210. More detailed information about tags 231, folders 232, and notes 233 will be described below with respect to FIG. 3A-3D.

Software application 220 further includes transcriber 236. Transcriber 236 is configured to transcribe input data 256b in the form of audio data into textual data. Transcriber 236 is especially relevant and necessary for note taking for users of computing device 210 with disabilities, such as deafness. In addition, transcriber 236 is also helpful for those who don't wish to transcribe their own audio data, and wish to rely on transcriber 236 to create textual transcripts of audio data. In implementations where transcriber 236 is utilized, user 204 of computing device 210 is still able to receive transcription of input data 256b and dynamically make modifications and edits to the textual data to create custom data 234. More detail with respect to transcriber 236 will be described below with respect to FIG. 3A.

Transcriber 236 includes transcriber settings 237. Transcriber settings 237 may include language settings, text size settings, spacing settings, or other settings relating to transcriber 236.

Now referring to FIGS. 3A-3D, FIGS. 3A-3D illustrate implementations of software application 300a-300d, respectively, on computing device 310. The orientations and illustrations of software application 300a-300d (collectively referred to herein as software application 300) are not intended to be limiting and are illustrated for exemplary purposes only. In addition, any functionality included in either of software application 300a-300d can be interchangeably associated with any of the other functionalities of software application 300a-300d. It should be noted that software application 300a-300d and computing device 310 correspond respectively to software application 220 and computing device 210 of FIG. 2.

Now referring to FIG. 3A, FIG. 3A illustrates a computing device and associated software application for use in the system of FIG. 1, according to one implementation of the present disclosure. Computing device 310 is utilizing software application 330a during reception of the input data from the broadcast terminal, such as broadcast terminal 201 of FIG. 2. As such, the incoming waveform 371 provides visual feedback of the incoming input data. Although waveform 371 is illustrated, in implementations where input data includes video data or presentation data, the video or presentation data may also be visually represented on computing device 310 during reception of the input data.

Software application 300a also includes record button 372. Record button 372 allows the user of the computing device 310 to start and stop recording of the input data.

Software application 300a further includes quick notes 373 which allows the user of computing device 310 to create notes to be associated with the input data and thus create custom data. Quick notes 373 may also allow the user to go directly to an alternate screen, such as that illustrated in FIG. 3C. Quick notes 373 enables the input data to be modified to include notes simultaneously with the reception of the input data by computing device 310 such that notes created using quick notes 373 can be dynamically associated with the input data to create custom data. Quick notes 373 will be described in more detail below with respect to FIG. 3C.

Software application 330a also includes flags 374. Flags 374 enable the user of computing device 310 to insert flags into the input data, such as that illustrated with flag 376, to notify the user of where to create partitions in the input data, for example. As such, flags 374 may include in flags 377, for generating a visual notification of a new speaker, or where a new conversation starts, or where a new recording should be started, and may include out flags 378, for generating a visual notification of a speaker ending, a conversation ending, or where a recording should be ended. As such, flags 347 may be utilized to create partitions in the input data.

In some implementations, in flags 377 and out flags 378 may automatically create partitions in the input data when selected, such that custom data including partitioned input data is created. In other implementations, in flags 377 and out flags 378 may only be used as visual notifications to aid the user in creating partitions during playback or after the initial reception of the input data from the broadcast terminal. For example, if the user inserts flag 376, the input data may be automatically partitioned at the location in the input data as illustrated by the dashed line above flag 376, or may allow the user to later create a partition at the location of flag 376.

In flags 377 and out flags 378 may also have an option to insert the flag at a previous time. For example, if a new speaker starts talking, but the user doesn't insert the flag in time, they can insert an in flag 377 with a “−10 sec” selection such that in flag 377 is inserted 10 seconds earlier in the recording. Any time increment can be selected or created as part of software application 300a.

Flags 374 may also include clear last flag 379 functionality. Clear last flag 379 allows the user to clear the last flag created, if it was created accidentally, or if the flag is no longer desired.

Flags 374 may be a button that when held down by the user creates a pop-up box 375 that allows the user to select in flags 377, out flags 378, or to clear last flag 379.

It should be noted that quick notes 373 may be one functionality of notes 233 of FIG. 2 and flags 374 may be one functionality of tags 231 of FIG. 2.

Software application 300a also includes transcriber 380. It should be noted that transcriber 380 corresponds to 236 of FIG. 2. In the illustration of FIG. 3A, transcriber 380 is turned on, as indicated by the check mark next to “Transcribe.” As such, the textual information transcribed from the input data appears in the transcribe box 383 on the computing device 310 display. In implementations where transcriber 380 is being utilized, the user may insert flags 374 into the textual transcription in the transcribe box 383, for example. In some implementations, when flags 374 are inserted into the input data flags 374, such as flag 376, appear in both waveform 371 and transcribe box 383.

Transcriber 380 also includes additional features such as edit 382 and highlight 381. Edit 382 allows the user to edit the textual data if transcriber 380 is not accurate or if a change is desired. When the user utilizes edit 382 to modify the input data, custom data is created. Highlight 381 allows user to highlight the textual data in transcribe box 383, such as key points or information deemed important. As such, the custom data created from the input data may include edited textual information, highlighting of textual information, and pre-set partitions in the textual data, using flags 374.

Software application 300a also includes editing tab 384, notes tab 385, and setting tab 386 which take the user to alternate screens or modes when selected. Software application 300a, similarly, is triggered when the user selects the recording tab 387.

Now referring to FIG. 3B, FIG. 3B is another illustration of a computing device and associated software application for use in the system of FIG. 1, according to one implementation of the present disclosure. Software application 300b illustrates an example of editing tab 384.

Software application 300b is configured to allow the user to edit and modify the input data and custom data, such as recordings 228 of FIG. 2, after recording is completed. However, any of the features of software application 300b may be implemented simultaneously with reception of the input data from the broadcast terminal. For example, create new clip button 391 may be implemented in addition to or in lieu of flags 374 such that a partition in the input data is created dynamically and simultaneously with reception of input data from the broadcast terminal.

Similar to that described above with respect to flags 374, create new clip 391 may be a button that when pressed triggers pop up box 392 allowing the user to set the partition at a prior point in time in the input data. Once a partition is created utilizing flag 376, for example, the user may select clear last flag 379 to remove flag 376 from the custom data.

Software application 300b also optionally includes waveform 371 and transcribe box 383. When editing, the user is able to view flags 374, such as flag 376, included in waveform to aid the user in creating partitions. For example, the user may notice flag 376 and select create new clip 391 at the location of flag 376 in the custom data to create partition and thus a new clip. The new clip can then be individually modified, and so, until a final set of recordings 228 is created. In addition, user may make additional edits and highlights of textual data in transcribe box 383 utilizing software application 300b.

Software application 300b also includes playback features 388, which include rewind, pause, play, and fast-forward. Playback features 388 allow the user to navigate through recordings 288, for example. Playback features 388 may also include a stop button, a next clip button, a previous clip button, or any additional buttons necessary for navigation through input data and/or custom data.

Software application 300b further includes notes tab 385, recording tab 387, and settings tab 386.

Now referring to FIG. 3C, FIG. 3C is another illustration of a computing device and associated software application for use in the system of FIG. 1, according to one implementation of the present disclosure. As noted above with respect to FIG. 3A, software application 300b may be triggered by selecting quick notes 373, for example.

Software application 300c is configured to allow the user of computing device 310 to create quick notes to modify the input data during reception of the input data from the broadcast terminal. The notes are thus associated with the entire clip, the individual segment of the clip that has been partitioned, or a particular moment of span of time in the clip.

Software application 300c includes quick select feature 393 configured to allow the user to quickly scroll through lists of key words to create quick notes. The lists may be any type of lists, or include any types of information. The lists may be created at an earlier time, such as before the recording is to take place, or may be created on the go during reception of the input data from the broadcast terminal, or a combination of the two. In the illustration of FIG. 3C, quick select feature 393 may include lists for a classroom environment. As such, the speaker, action, and subject are individual lists that allow the user to scroll through and make selections. As illustrated, in a classroom environment, the speaker may come from a broad category such as professor, or a narrower category, such as Dr. Ames. The action defines what the speaker is doing, such as discussing, or explaining. The subject is the topic of the discussion or explanation, such as behavior, or science. In implementations where the input data includes video data, the speaker may become an actor for example, and the action may be dancing, or the like, while the subject may be what they are dancing to. In implementations where the input data includes presentation data, the lists may include subject, presenter, etc.

The user utilizes quick select feature 393 to select from each of the lists. In the illustration of FIG. 3, the user selected “Student Talks About Behavior” which appears in note box 394. As such, “Student Talks About Behavior” can be dynamically applied as a note associated with the input data to create custom data. The note may be applied for the entire clip, a portion of the clip, or at a specific moment in the clip. Once the recording is finished, the user can go back through the recording, such as recordings 228 of FIG. 2, and see the note associated with the recording. As such, the user is able to simultaneously create notes for associating with the input data during reception of the input data when the information is freshest on the user's mind.

Software application 300c further includes playback features 388, notes tab 385, editing tab 384, recording tab 387, and settings tab 386. Setting tab 386 is configured to allow the user to change settings of the software application, such as the features available, the date/time, volume, video quality, and other features associated with software application 300.

Now referring to FIG. 3D, FIG. 3D is another illustration of a computing device and associated software application for use in the system of FIG. 1, according to one implementation of the present disclosure. Software application 300d is triggered when the user selects the notes tab 385. Notes tab 385 includes, for example, recording 228 and associated notes 233 from database 226 of FIG. 2.

Software application 300d allows the user to go back and view the individual clips that have been saved on computing device 310. For example, each of clip 1, clip 2, and clip 3 may be segments that were partitioned from the input data during one event, such as one class period. During the class period, the user may have created partitions in the input data to end up with three clips: clip 1, clip 2, and clip 3. In addition, the user may have associated notes with the clip. In the illustration of FIG. 3D, final notes box 395 includes a longer note than that of note box 394, but includes the language “Student talks about behavior.” As such, the user may have created the quick note “Student talks about behavior” using quick notes 373, and then utilized final note box 395 to add more detailed information after hearing the playback. In this case, the user may have gleaned the additional information “primarily methodological individualism” from the textual data generated by transcriber 380.

Ultimately, due to the ability of software application 300 to enable the user to dynamically modify and customize the input data from the broadcast terminal during reception of the input data, the user has custom data including partitioned segments, associated notes, flags, and transcribed textual data before having to playback the final recording. In addition, because computing device 310 is receiving the same quality input data as that of the broadcast terminal, which directly receives the input data from the input device, there is no loss of quality in the final recording.

Software application 300d further includes note recorder button 397 configured to allow the user to make voice notes of the clips. For example, the user may wish to create a short clip explaining the entire clip in their own words, for quick reference at a later time.

Software application 300d further includes editing tab 384, recording tab 387, settings tab 386, and playback features 388.

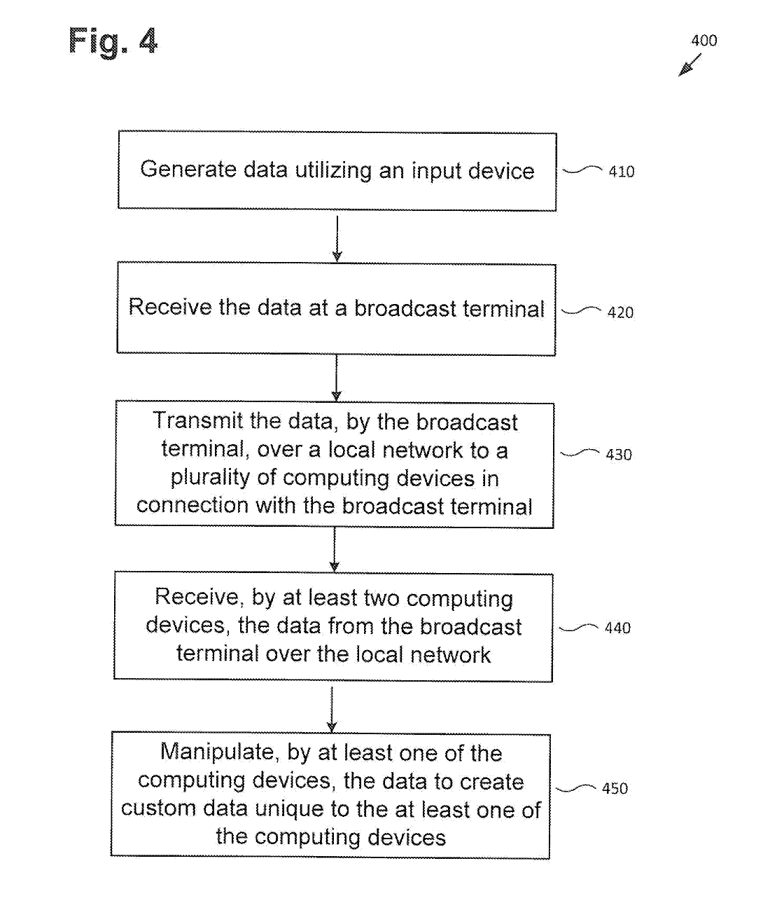

Now referring to FIG. 4, FIG. 4 shows a flowchart a method for use by a broadcast terminal and networked devices, according to one implementation of the present disclosure. The approach and technique indicated by flowchart 400 are sufficient to describe at least one implementation of the present disclosure, however, other implementations of the disclosure may utilize approaches and techniques different from those shown in flowchart 400. Furthermore, while flowchart 400 is described with respect to FIG. 1, the disclosed inventive concepts are not intended to be limited by specific features shown and described with respect to FIG. 2. Furthermore, with respect to the method illustrated in FIG. 4, it is noted that certain details and features have been left out of flowchart 400 in order not to obscure the discussion of inventive features in the present application.

Flowchart 400 (at 410) includes generating data utilizing an input device. For example, user 202 of input device 240 utilizes input device 240 to generate input data 256a. Input data 256a may be audio data, video data, presentation data, or any combination of the three, which may be generated from input device 240 which may be any of a microphone, a video camera, a computing device, a voice recorder, or the like.

Flowchart 400 (at 420) includes receiving the data at a broadcast terminal. For example, broadcast terminal 201 receives input data 256a over network 290 or through a wired connection. In implementations where input data 256a includes multiple data types, such as audio and video, broadcast terminal 201 may receive each input type as a bundle of input data 256a, or may receive input data 256a as segmented data including separate audio and video data, for example.

Flowchart 400 (at 430) includes transmitting the data, by the broadcast terminal, over a local network to a plurality of computing devices in connection with the broadcast terminal. For example, the broadcast terminal 201 transmits input data 256a over network 290 to a plurality of devices, including computing device 210, where the plurality of devices are connected to broadcast terminal 201. Computing device 210 may establish a connection to broadcast terminal 201 using pin code 257b, for example. Network 290 is preferably a local network, such as a Bluetooth network or a Wi-Fi network operating as a Local Area Network (LAN).

Flowchart 400 (at 440) includes receiving, by the at least two computing devices, the data from the broadcast terminal over the local network. For example, at least two computing devices of the plurality of devices, including computing device 210, receives input data 256b from broadcast terminal 201 over network 290. Each of the at least two computing devices in connection with broadcast terminal 201 receives the same input data 256b.

Flowchart 400 (at 450) includes manipulating, by at least one of the computing devices, the data to create custom data unique to the at least one of the computing devices. For example, at least one of the computing devices, including computing device 210, that receives input data 256b from broadcast terminal 201 manipulates input data 256b to create custom data 234. Computing device 210 may manipulate input data 256b in any of the variety of ways described above, including adding tags 231, notes 233, flags, and any additional data, as metadata, for example, to input data 256b to create custom data 234. Custom data 234 may also be generated by creating partitions in input data 256b, transcribing input data 256b, or any of the additional ways described above in the present disclosure.

The computing devices, including computing device 210, are configured to manipulate input data 256b simultaneously with its reception from broadcast terminal 201 over network 290. As such, input data 256b may be dynamically modified and manipulated to create custom data 234 by the computing devices. The computing devices are also configured to manipulate input data 256b after reception, such as during playback. Ultimately, the computing devices are configured to store custom data 234 as recordings 228. Because each of the computing devices is configured to manipulate input data 256b, each of the computing devices, including computing device 210, ultimately generate unique custom data 234. However, because each of the computing devices receives substantially similar quality input data 256b from broadcast terminal 201, the quality each unique custom data 234 for each of the computing devices is not sacrificed.

The above described implementations of the invention are presented for the purposes of illustration and not of limitation, and the present invention is limited only by the claims which follow.

What is claimed is:

1. A system comprising:
an input device configured to transmit data;
a broadcast terminal configured to receive the data from the input device and transmit the data over a local network to a plurality of computing devices in connection with the broadcast terminal, the broadcast terminal further configured to dynamically control the transmission of the data to and the connection to each of the plurality of computing devices; and
at least two computing devices configured to receive the data from the broadcast terminal over the local network and to dynamically manipulate the data to create custom data, the custom data unique to each of the computing devices.

2. The system of claim 1, wherein the broadcast terminal being configured to dynamically control the transmission of the data to each of the plurality of computing devices includes:
muting the transmission of the data such that the data is received by the broadcast terminal but not transmitted to at least one of the plurality of computing devices.

3. The system of claim 2, wherein the muting the transmission of the data includes selective muting such that at least one of the plurality of computing devices in connection with the broadcast terminal receives the data and at least one of the plurality of computing devices in connection with the broadcast terminal does not receive the data.

4. The system of claim 1, wherein the broadcast terminal being configured to dynamically control the connection to each of the plurality of computing devices includes:
terminating the connection between at least one of the plurality of computing devices and the broadcast terminal.

5. The system of claim 1, wherein the broadcast terminal includes a mute, a clear connection, and an on/off button configured to at least momentarily stop transmission of the data to at least one of the plurality of computing devices in connection with the broadcast terminal while maintaining the connection to the at least one of the plurality of computing devices, terminate the connection with at least one of the plurality of computing devices in connection with the broadcast terminal, and power on and off the broadcast terminal, respectively.

6. The system of claim 1, wherein the dynamic manipulation of the data includes:
manually creating partitions in the data such that the custom data includes multiple segments of the data; and
associating notes and metadata tags with each of the multiple segments of the data included in the custom data.

7. The system of claim 1, wherein the computing devices are further configured to manipulate the data and the custom data after the connection with the broadcast terminal is terminated.

8. The system of claim 1, wherein the input device comprises at least one of a microphone and a video camera and the data comprises at least one of audio and video data, respectively.

9. The system of claim 1, wherein the computing devices include at least one of a mobile phone, a computer, a tablet, and a voice recorder.

10. The system of claim 1, wherein the local network is at least one of a Bluetooth network and a Wi-Fi network.

11. A system comprising:
an input device configured to transmit data;
a broadcast terminal configured to receive the data from the input device and simultaneously transmit the data over a local network to a plurality of computing devices in connection with the broadcast terminal; and
at least two computing devices configured to receive the data from the broadcast terminal over the local network and to dynamically manipulate the data to create custom data, the custom data unique to each of the computing devices,
wherein the manipulation of the data includes:
dynamically creating partitions in the data during receiving of the data from the broadcast terminal such that the custom data includes multiple segments of the data;
manually creating partitions in the data after connection with the broadcast terminal has been terminated; and
associating notes and metadata tags with each of the multiple segments of the data included in the custom data.

12. The system of claim 11, wherein the computing devices are further configured to manipulate the data and the custom data after the connection with the broadcast terminal is terminated.

13. The system of claim 11, wherein the input device comprises at least one of a microphone and a video camera and the data comprises at least one of audio and video data, respectively.

14. The system of claim 11, wherein the computing devices include at least one of a mobile phone, a computer, a tablet, and a voice recorder.

15. The system of claim 11, wherein the broadcast terminal includes a mute, a clear connection, and an on/off button configured to at least momentarily stop transmission of the data to at least one of the plurality of computing devices in connection with the broadcast terminal while maintaining the connection to the at least one of the plurality of computing devices, terminate the connection with at least one of the plurality of computing devices in connection with the broadcast terminal, and power on and off the broadcast terminal, respectively.

16. A method comprising:
generating data utilizing an input device;
receiving the data at a broadcast terminal;
transmitting the data simultaneously, by the broadcast terminal, over a local network to a plurality of computing devices in connection with the broadcast terminal, the broadcast terminal configured to dynamically control the transmission of the data to and the connection to each of the plurality of computing devices; and
receiving, by at least two computing devices in connection with the broadcast terminal, the data from the broadcast terminal over the local network; and
dynamically manipulating, by each of the at least two computing devices, the data to create custom data unique to each of the computing devices.

17. The method of claim 16, wherein the dynamic controlling of the transmission of the data by the broadcast terminal to each of the plurality of computing devices includes:
muting the transmission of the data such that the data is received by the broadcast terminal but not transmitted to at least one of the plurality of computing devices.

18. The method of claim 16, wherein the muting the transmission of the data includes selective muting such that at least one of the plurality of computing devices in connection with the broadcast terminal receives the data and at least one of the plurality of computing devices in connection with the broadcast terminal does not receive the data.

19. The system of claim 16, wherein the dynamic controlling of the connection to each of the plurality of computing devices includes:
terminating the connection between at least one of the plurality of computing devices and the broadcast terminal.

20. The method of claim 16, wherein the step of dynamically manipulating the data to create custom data includes:
manually creating partitions in the data such that the custom data includes multiple segments of the data; and
associating notes and metadata tags with each of the multiple segments of the data included in the custom data.
